(19) United States
(12) Patent Application Publication
(10) Pub. No.: US 2007/0051415 A1
(43) Pub. Date: Mar. 8, 2007

(54) MICROVALVE SWITCHING ARRAY

(75) Inventor: Tzu-Yu Wang, Maple Grove, MN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/162,336

(22) Filed: Sep. 7, 2005

(51) Int. Cl. F16K 7/00

(52) U.S. Cl. 137/861

(57) ABSTRACT

A low power switching valve array employing two or more actuated microvalves that are arranged to accommodate any desired number of inlets and any desired number of outlets. Fluid entering one of inlets may be directed to any one or more of the outlets. In one illustrative embodiment, a valve body may have a valve array inlet, and two or more pumping chambers defined within the valve body. Each of the two or more pumping chambers have an inlet in fluid communication with the valve array inlet. In another illustrative embodiment, a valve body may have a valve array outlet, and two or more pumping chambers defined within the valve body. Each of the two or more pumping chambers have an outlet in fluid communication with the valve array outlet.

### TECHNICAL FIELD

The present invention relates generally to microvalves, and more particularly to microvalves arranged in switching arrays.

### BACKGROUND

Many industrial, commercial, aerospace, military and other applications depend on reliable valves for fluid (liquid and/or gas) handling. In a chemical plant, for example, valves are often used to control the flow of fluid throughout the facility. Likewise, in an airplane, valves are often used to control air and fuel delivery, as well as some of the hydraulic systems that drive the control surfaces of the airplane. These are just a few examples of the many applications that can depend on reliable valves for fluid (liquid and/or gas) handling.

In some instances, there is a need for providing reliable switching using arrays of valves. A need remains for improved switching valve arrays, and in particular, a need remains for low power and micro-scale switching arrays.

### SUMMARY

The present invention pertains to a low power switching valve array that can employ two or more electrostatically actuated microvalves that are arranged to accommodate a desired number of inlets and a desired number of outlets. In some configurations, fluid entering one or more inlets may be directed to a desired one or more of the outlets, depending on the desired application.

In one illustrative embodiment of the present invention, an electrostatically actuated switching valve array is provided that includes a valve body, a first chamber having a first inlet and a first outlet defined within the valve body, and a first diaphragm disposed within the valve body. The first diaphragm may have a first or rest position in which fluid flow to the first outlet is restricted, and a second or electrostatically actuated position in which fluid flow to the first outlet is permitted.

A second chamber having a second inlet and a second outlet is also defined within the valve body. A second diaphragm is disposed within the second chamber. The second diaphragm has a first or rest position in which fluid flow to the second outlet is restricted, and a second or electrostatically actuated position in which fluid flow to the second outlet is permitted. In this illustrative embodiment, a valve array inlet is in fluid communication with the first inlet and the second inlet. In other embodiments, a valve array outlet is in fluid communication with the first outlet and the second outlet.

In some instances, the first diaphragm and the second diaphragm are adapted to be independently actuate in order to selectively prevent fluid entering the valve array inlet from exiting the first outlet and the second outlet, to permit the fluid to exit from one of the first outlet or the second outlet, or to permit the fluid to exit through both the first outlet and the second outlet.

In some illustrative embodiments, the valve body has a first surface and a second opposing surface. The valve array inlet(s) may be located on the first surface. In some instances, the first inlet and the second inlet are also located on the first surface. In other cases, the first inlet and/or the second inlet are located on the second surface.

In some embodiments, the first chamber may include a first normally open port positioned within the first chamber such that fluid entering the first chamber exits through the first normally open port when the first diaphragm is positioned to restrict fluid from entering the first outlet. In some embodiments, the first diaphragm may have at least one aperture positioned to permit fluid to flow from the first inlet to the first normally open port when the first diaphragm is positioned to restrict fluid from entering the first outlet.

The second chamber may also include a second normally open port positioned within the second chamber such that fluid entering the second chamber exits through the second normally open port when the second diaphragm is positioned to restrict fluid from entering the second outlet. In some embodiments, the second diaphragm may also have at least one aperture positioned to permit fluid to flow from the second inlet to the second normally open port when the second diaphragm is positioned to restrict fluid from entering the second outlet.

In some embodiments, the first chamber may include a first pressure control port positioned such that fluid entering the first chamber is prevented from exiting the first pressure control port. The first diaphragm may be configured to prevent fluid from passing from the first inlet to the first pressure control port, if desired. Likewise, the second chamber may also include a second pressure control port positioned such that fluid entering the second chamber is prevented from exiting the second pressure control port. The second diaphragm may be configured to prevent fluid from passing from the second inlet to the second pressure control port.

The above summary of the present invention is not intended to describe each disclosed embodiment or every implementation of the present invention. The Figures, Description and Examples which follow more particularly exemplify these embodiments.

### BRIEF DESCRIPTION OF THE FIGURES

The invention may be more completely understood in consideration of the following detailed description of various embodiments of the invention in connection with the accompanying drawings, in which:

FIG. 1 is a diagrammatic cross-sectional view of a switching valve array in accordance with an embodiment of the present invention;

FIG. 2 illustrates the switching valve array of FIG. 1, shown in an open configuration in accordance with an embodiment of the present invention;

FIG. 3 is a diagrammatic top view of a four valve switching array in accordance with an embodiment of the present invention;

FIG. 4 is a diagrammatic cross-sectional view of a switching valve array in accordance with an embodiment of the present invention;

FIG. 5 a diagrammatic cross-sectional view of a switching valve array in accordance with an embodiment of the present invention;

FIG. 6 a diagrammatic cross-sectional view of a switching valve array in accordance with an embodiment of the present invention;

FIG. 7 a diagrammatic cross-sectional view of a switching valve array in accordance with an embodiment of the present invention;

FIG. 8 a diagrammatic cross-sectional view of a switching valve array in accordance with an embodiment of the present invention;

FIG. 9 a diagrammatic cross-sectional view of a switching valve array in accordance with an embodiment of the present invention;

FIG. 10 a diagrammatic cross-sectional view of a switching valve array in accordance with an embodiment of the present invention;

FIG. 11 a diagrammatic cross-sectional view of a switching valve array in accordance with an embodiment of the present invention; and

FIG. 12 a diagrammatic cross-sectional view of a switching valve array in accordance with an embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DESCRIPTION

The following description should be read with reference to the drawings, in which like elements in different drawings are numbered in like fashion. The drawings, which are not necessarily to scale, depict selected embodiments and are not intended to limit the scope of the invention. Although examples of construction, dimensions, and materials are illustrated for the various elements, those skilled in the art will recognize that many of the examples provided have suitable alternatives that may be utilized.

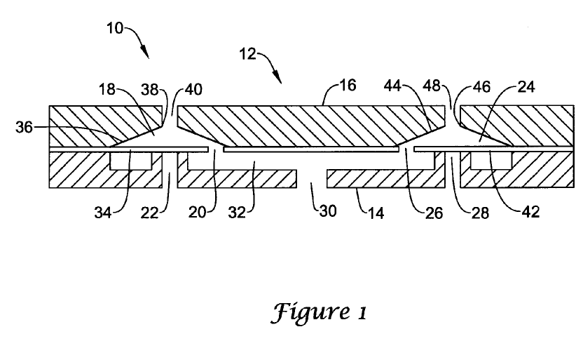

FIG. 1 is a diagrammatic cross-sectional view of a valve array 10 having a valve body 12. Valve body 12 has a first side 14 and a second opposing side 16. As illustrated, first side 14 is on the bottom while second side 16 is on the top. This arrangement is arbitrary, as it is contemplated that valve array 10 may function equally well regardless of orientation. A first chamber 18 has a first inlet 20 and a first outlet 22. A second chamber 24 has a second inlet 26 and a second outlet 28. Valve body 12 includes a valve array inlet 30 that is fluid communication with first inlet 20 and second inlet 26 through a channel 32.

Valve body 12 may be constructed of any suitable semi-rigid or rigid material, such as plastic, ceramic, silicon, etc. In one illustrative embodiment, valve body 12 is constructed by molding a high temperature plastic such as ULTEM™ (available from General Electric Company, Pittsfield, Mass.), CELAZOLE™ (available from Hoechst-Celanese Corporation, Summit, N.J.), KETRON™ (available from Polymer Corporation, Reading, Pa.), or some other suitable material.

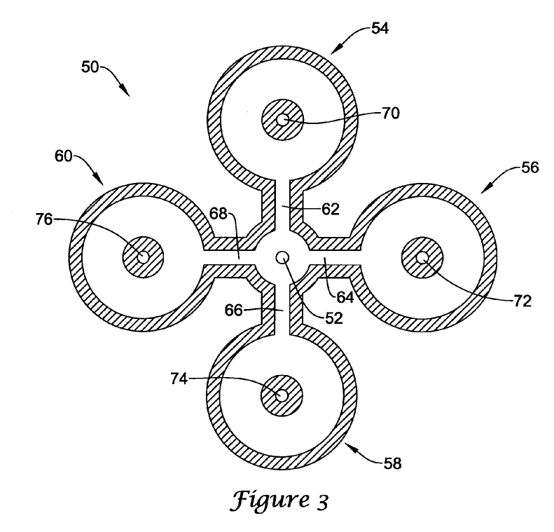

First chamber 18 includes an electrostatically actuated diaphragm 34 that can be actuated by applying a voltage between an electrode (not illustrated) within or on diaphragm 34 and an electrode 36 placed along an opposite side of first chamber 18 along, for example, surface 38. In FIG. 1, diaphragm 34 is seen in its rest, or relaxed position. As will be discussed more fully with respect to FIG. 3, diaphragm 34 can be electrostatically actuated to a position in which diaphragm 34 is electrostatically pulled proximate surface 38, thereby permitting fluid entering first inlet 20 to pass through to first output 22.

Diaphragm 34 may be biased such that it returns to its rest position absent electrostatic actuation. In some instances, it is contemplated that first chamber 18 may include a second electrode (not illustrated) positioned such that diaphragm 34 may also be electrostatically actuated into its rest position.

In some instances, electrode 36 may include one or more dielectric layers (not shown) to prevent shorting between electrode 36 and the electrode disposed within or on diaphragm 34. Electrode 36 may be formed of any suitable material using any suitable technique.

Diaphragm 34 may be formed of any suitable material. In some instances, diaphragm 34 may be formed of a material having elastic, resilient, flexible or other elastomeric properties. In some cases, diaphragm 34 may be formed of a generally compliant material. In particular, diaphragm 34 may be formed of a polymer such as ULTEM™ (available from General Electric Company, Pittsfield, Mass.), KAPTON™ (available from E. I. du Pont de Nemours & Co., Wilmington, Del.), KALADEX™ (available from ICI Films, Wilmington, Del.), MYLAR™ (available from E. I. du Pont de Nemours & Co., Wilmington, Del.), or any other suitable material. The diaphragm may be sandwiched between the upper body portion and the lower body portion in a lamination process, if desired.

In the illustrative embodiment, first chamber 18 also includes a first normally open port 40. In some instances, first normally open port 40 helps diaphragm 34 more readily move within first chamber 18. In some cases, first normally open port 40 permits first chamber 18 to operate as a three way valve. In some instances, first normally open port 40 may provide for recycle by recycling the fluid back to the input port 30.

When diaphragm 34 is in its rest position, sealing first outlet 22, fluid entering through first inlet 20 is permitted to exit through first normally open port 40. When diaphragm 34 has been actuated to its actuated position, first normally open port 40 is sealed and fluid exits through first outlet 22.

Second chamber 24 is configured similarly to first chamber 18. Second chamber 24 includes an electrostatically actuated diaphragm 42 that can be actuated by applying a voltage between an electrode (not seen in this Figure) within or on diaphragm 42 and an electrode 44 placed along an opposite side of second chamber 24 along surface 46. In FIG. 1, diaphragm 42 is illustrated in its rest, or relaxed position, but diaphragm 42 can be electrostatically actuated to a position in which it is proximate surface 46, thereby permitting fluid entering second inlet 26 to pass through to second output 28. In some instances, electrode 44 may include one or more dielectric layers (not shown) to prevent shorting between electrode 44 and the electrode disposed within or on diaphragm 42.

In the illustrative embodiment, second chamber 24 also includes a second normally open port 48. In some instances, second normally open port 48 helps diaphragm 42 more readily move within second chamber 24. In some cases, second normally open port 48 permits second chamber 24 to operate as a three way valve. In some instances, second normally open port 48 may provide for recycling, as discussed above.

When diaphragm 42 is in its rest position, sealing second outlet 28, fluid entering through second inlet 26 is permitted to exit through second normally open port 48. When diaphragm 42 has been actuated to its actuated position, second normally open port 48 is sealed and fluid exits through second outlet 28.

It can be seen that a fluid entering valve array inlet 30 may pass through channel 32 and may, depending on the positions of diaphragm 34 and diaphragm 42, take one or more of four possible exit routes from valve array 10.

While not illustrated in FIG. 1, it is contemplated that a third valve chamber could be positioned in fluid communication with valve array inlet 30 and could be actuated between a position in which fluid entering the third valve chamber is permitted only to pass to first inlet 20 and a position in which fluid entering the third valve chamber is permitted only to pass to second inlet 26.

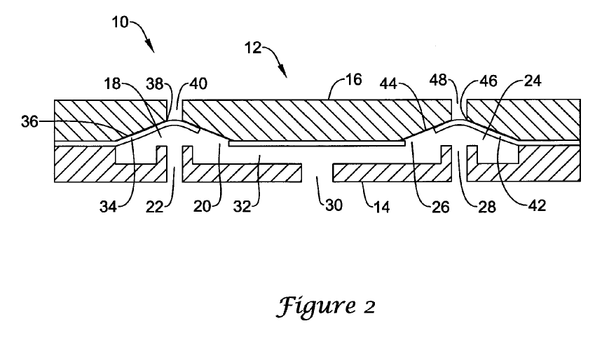

In FIG. 2, it can be seen that diaphragm 34 and diaphragm 42 have both been actuated into their actuated positions. In this position, diaphragm 34 blocks fluid flow through first normally open port 40 but permits fluid entering through first inlet 20 to exit through first outlet 22. Similarly, diaphragm 42 blocks fluid flow through second normally open port 48, but permits fluid entering through second inlet 26 to exit through second outlet 28. It should be recognized, however, that diaphragm 34 and diaphragm 42 can be independently actuated.

In FIGS. 1 and 2, valve array 10 includes only two valve chambers (first chamber 18 and second chamber 24). However, it is contemplated that a valve array may be provided that includes any desired number of valve chambers. The valve chambers may be arranged in linear layout (as seen in FIGS. 1 and 2), or in a rotary layout in which a plurality of inputs surround a central output, or perhaps a plurality of outputs surround a central input. Any other suitable layout may also be used, as desired.

FIG. 3 diagrammatically shows a top view of a valve array 50 that has a central valve array inlet 52 surrounded by a first valve chamber 54, a second valve chamber 56, a third valve chamber 58 and a fourth valve chamber 60. Construction of each valve chamber may be considered similar to that discussed with respect to FIGS. 1 and 2, and thus valve chambers 54, 56, 58 and 60 are each considered to have an input (not illustrated) in fluid communication with central valve array inlet 52 via channels 62, 64, 66 and 68, respectively. Fluid entering through central valve array inlet 52 may be directed to exit through any of first outlet 70, second outlet 72, third outlet 74 or fourth outlet 76 by electrostatically actuating the appropriate diaphragm or diaphragms.

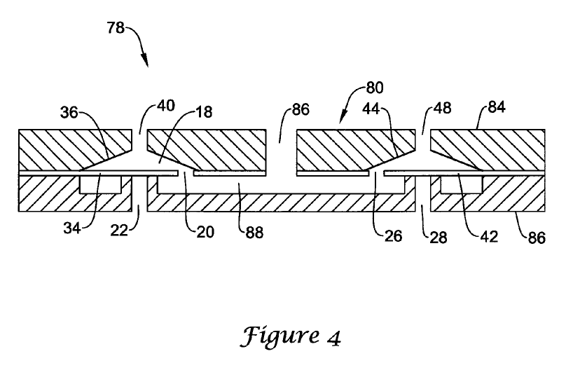

FIG. 4 is similar to FIG. 1, in which a valve array 78 includes a valve body 80 having a first side 82 and a second opposing side 84. First chamber 18 and second chamber 24, as discussed previously, are defined within valve body 80. In FIG. 4, however, valve array inlet 86 is disposed on the second opposing side 84, while first outlet 22 and second outlet 28 are disposed on the first side 86. In some instances, packaging requirements and perhaps desired performance characteristics may impact which side first outlet 22, second outlet 28 and valve array inlet 86 are disposed. In the illustrative embodiment, a channel 88 fluidly connects valve array inlet 86 with first inlet 20 and second inlet 24. Operation of first chamber 18 and second chamber 24 are as discussed with respect to FIGS. 1 and 2.

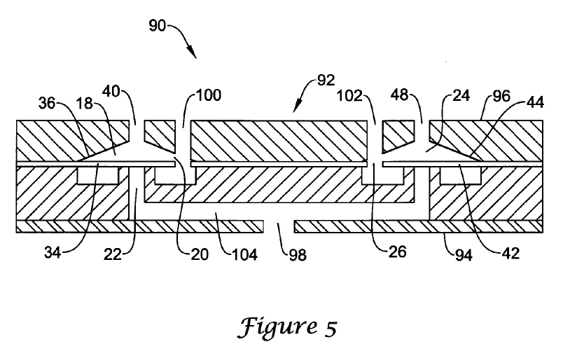

FIG. 5 diagrammatically illustrates a valve array 90 having a valve body 92. Valve body 92 has a first side 94 and a second opposing side 96. First chamber 18 and second chamber 24, as discussed previously, are defined within valve body 92. In FIG. 5, valve body 92 is configured to include a single valve body outlet 98 and two inlets, a first valve body inlet 100 and a second valve body inlet 102. First valve body inlet 100 is in fluid communication with first inlet 20 while second valve body inlet 102 is in fluid communication with second inlet 26.

First outlet 22 and second outlet 28 are in fluid communication with valve body outlet 98 through a channel 104. In the illustrated embodiment, first valve body inlet 100 and second valve body inlet 102 are disposed along the second opposing side 96, while valve body outlet 98 is disposed along the first side 94. As discussed, it is contemplated that packaging and other requirements may dictate the position of the individual components.

Valve array 90 is configured that a first fluid entering through valve body inlet 100 will pass through first inlet 20 into first chamber 18. Depending on the position of diaphragm 34, the fluid will either exit through first normally open port 40, or will exit first outlet 22 and will then pass through channel 104 and exit through valve body outlet 98. Similarly, a second fluid entering through valve body inlet 102 will pass through second inlet 26 into second chamber 24. Depending on the position of diaphragm 42, fluid will either exit through second normally open port 48 or will exit second outlet 28 and will the pass through channel 104 and exit through valve body outlet 98.

Thus, it should be recognized that valve array 90 is configured to selectively pass a first fluid while preventing flow of a second fluid, permit a second fluid to flow while preventing flow of a first fluid, or to mix the first and second fluids into a combined fluid exiting through valve body outlet 98. It should be recognized that any of first fluid exiting through first normally open port 40 or any of the second fluid exiting through second normally open port 48 may, in some cases, be recycled, similar to that discussed above.

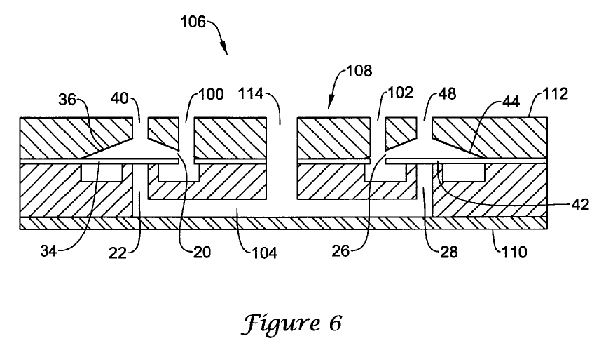

FIG. 6 diagrammatically illustrates a valve array 106 that includes a valve body 108 having a first side 110 and a second side 112. First chamber 18 and second chamber 24, as discussed previously, are defined within valve body 108. Valve body 108 includes, similarly to valve body 92 (FIG. 5), first valve body inlet 100 and second valve body inlet 102. First valve body inlet 100 is in fluid communication with first inlet 20, while second valve body inlet 102 is in fluid communication with second inlet 26. Valve body 108 includes a valve body outlet 114.

First outlet 22 and second outlet 28 are in fluid communication with valve body outlet 114 through channel 104. In the illustrated embodiment, first valve body inlet 100, second valve body inlet 102 and valve body outlet 114 are all disposed along second opposing side 112. As discussed, it is contemplated that packaging and other requirements may dictate the desired position of the individual components.

Valve array 106 is configured that a first fluid entering through valve body inlet 100 will pass through first inlet 20 into first chamber 18. Depending on the position of diaphragm 34, the fluid will either exit through first normally open port 40 or will exit first outlet 22 and will then pass through channel 104 and exit through valve body outlet 114. Similarly, a second fluid entering through valve body inlet 102 will pass through second inlet 26 into second chamber 24. Depending on the position of diaphragm 42, fluid will either exit through second normally open port 48 or will exit second outlet 28 and will the pass through channel 104 and exit through valve body outlet 114.

Thus, it should be recognized that valve array 106 is configured to selectively pass a first fluid while preventing flow of a second fluid, permit a second fluid to flow while preventing flow of a first fluid, or to mix the first and second fluids into a combined fluid exiting through valve body outlet 114. It should be recognized that any of first fluid exiting through first normally open port 40 or any of the second fluid exiting through second normally open port 48 may, in some cases, be recycled, similar to that discussed above.

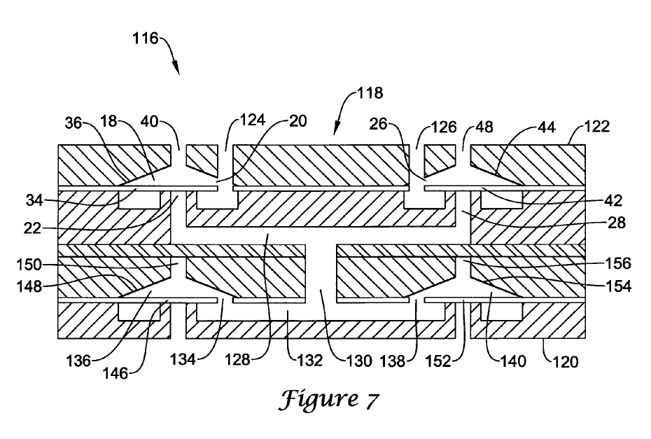

FIG. 7 diagrammatically illustrates a valve array 116 that includes a valve body 118 having a first side 120 and a second opposing side 122. A first valve body inlet 124 and a second valve body inlet 126 are disposed along the second opposing side 122. First chamber 18 and second chamber 24, as discussed previously, are defined within valve body 118. First valve body inlet 124 is in fluid communication with first inlet 20, while second valve body inlet 126 is in fluid communication with second inlet 26.

Valve array 116 is configured such that a first fluid entering through valve body inlet 124 will pass through first inlet 20 into first chamber 18. Depending on the position of diaphragm 34, the fluid will either exit through first normally open port 40 or will exit first outlet 22 and will then enter a channel 128. Similarly, a second fluid entering through valve body inlet 126 will pass through second inlet 26 into second chamber 24. Depending on the position of diaphragm 42, fluid will either exit through second normally open port 48 or will exit second outlet 28 and will enter channel 128.

Channel 128 leads to a vertical channel 130 and a horizontal channel 132, which is in fluid communication with a third inlet 134 of a third chamber 136 and a fourth inlet 138 of a fourth chamber 140. Third chamber 136 has a third outlet 142 while fourth chamber 140 has a fourth outlet 144.

Third chamber 136 includes an electrostatically actuated diaphragm 146 that is actuated by applying a voltage between an electrode present within or on diaphragm 146 and an electrode 148. A third normally open port 150 may help diaphragm 146 move and may, particularly in applications directed to gaseous fluids, permit third chamber 136 to function as a three-way valve. Third normally open port 150 may also provide for a recycle function. Third normally open port 150 may be considered as including a fluid outlet not illustrated in this diagrammatic cross-sectional view, or may be closed off if desired.

Fourth chamber 140 includes an electrostatically actuated diaphragm 152 that is actuated by applying a voltage between an electrode present within diaphragm 152 and an electrode 154. A fourth normally open port 156 may help diaphragm 152 move and may, particularly in applications directed to gaseous fluids, permit fourth chamber 140 to function as a three-way valve. Fourth normally open port 156 may also provide for a recycle function. Fourth normally open port 156 may be considered as including a fluid outlet not illustrated in this diagrammatic cross-sectional view, or may be closed off if desired.

As can be seen, any fluid that passes through first chamber 18 or second chamber 24 will pass through channel 128 into channel 130 and then into channel 132, which is in fluid communication with third inlet 134 and fourth inlet 138. Thus, the fluid will enter third chamber 136 and fourth chamber 140.

Fluid entering third chamber 136 will, depending on the position of diaphragm 146, either exit through third normally open port 150 or will pass through third outlet 142. Similarly, fluid entering fourth chamber 140 will, depending on the position of diaphragm 152, either exit through fourth normally open port 156 or will pass through fourth outlet 144.

It can be seen that valve array 116 provides for a number of possible permutations. For example, a fluid entering first valve body inlet 124 may exit first normally open port 40, third normally open port 150, fourth normally open port 156, third outlet 142 and/or fourth outlet 144. Similarly, fluid entering second valve body inlet 126 may exit second normally open port 48, third normally open port 150, fourth normally open port 156, third outlet 142 and/or fourth outlet 144. In some cases, this illustrative embodiment may be adapted to perform a multiplexer function. That is, the fluid entering the first valve body inlet 124 and the fluid entering the second valve body input 126 may be multiplexed between the third outlet 142 and the forth outlet 144. More generally, other embodiments can be provided for performing other logic functions, as desired.

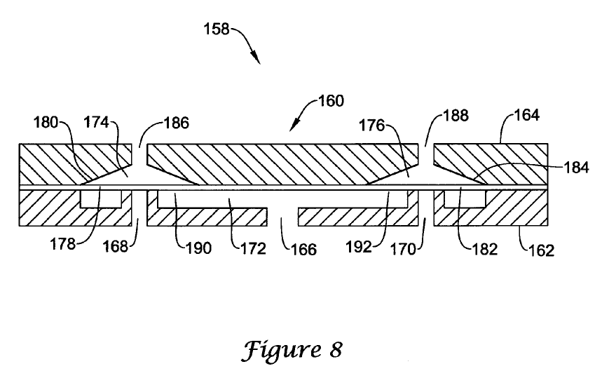

FIG. 8 diagrammatically illustrates a valve array 158 that includes a valve body 160 having a first side 162 and a second opposing side 164. Valve body 160 includes a valve body inlet 166, a first valve body outlet 168 and a second valve body outlet 170. First valve body outlet 168 is disposed adjacent a first chamber 174 while second valve body outlet 170 is disposed adjacent a second chamber 176.

As illustrated, valve body inlet 166, first valve body outlet 168 and second valve body outlet 170 are all disposed along the second opposing side 162 of valve body 160, although this is not required. As discussed, it is contemplated that packaging and other requirements may dictate the position of the individual components.

First chamber 174 includes an electrostatically actuated diaphragm 178 and an opposing electrode 180. Diaphragm 178 may be actuated by applying a voltage between an electrode present within or on the diaphragm 178 and electrode 180. Similarly, second chamber 176 includes an electrostatically actuated diaphragm 182 and an opposing electrode 184. Diaphragm 182 may be actuated by applying a voltage between an electrode present within or on the diaphragm 182 and electrode 184.

First chamber 174 also includes a first pressure control port 186 while second chamber 178 includes a second pressure control port 188. First pressure control port 186 and second pressure control port 188 may be provided to help diaphragms 178 and 182, respectively, flex, but do not provide fluid egress. In some instances, first pressure control port 186 and second pressure control port 188 may be open to atmosphere or some other control pressure, as desired. Valve array 158 is configured to accommodate any fluid, including conductive fluids, particularly since the fluid does not enter the space between diaphragm 178 and electrode 180 (first chamber 174) or between diaphragm 182 and electrode 184 (second chamber 176).

First chamber 174 includes a first inlet 190 while second chamber 176 includes a second inlet 192. Valve body inlet 166 is in fluid communication with a channel 172 that is itself in fluid communication with first inlet 190 at one end and with second inlet 192 at an opposing end.

If diaphragm 178 of first chamber 174 is in its relaxed or rest position, as illustrated in FIG. 8, no fluid will flow into first chamber 174. However, if diaphragm 178 has been electrostatically actuated into an actuated position in which diaphragm 178 moves toward first pressure control port 186, fluid will be allowed to pass through to first valve body outlet 168.

Similarly, if diaphragm 182 of second chamber 180 is in its relaxed or rest position, as illustrated in FIG. 8, no fluid will flow into second chamber 180. However, if diaphragm 182 has been electrostatically actuated into an actuated position in which diaphragm 182 moves toward second pressure control port 188, fluid will be allowed to pass through to second valve body outlet 170.

It can be seen, therefore, that fluid entering valve body inlet 166 may be permitted to pass only through first valve body outlet 168, to pass only through second valve body outlet 170, to pass through both first valve body outlet 168 and second valve body outlet 170, or to not pass through valve array 158 at all.

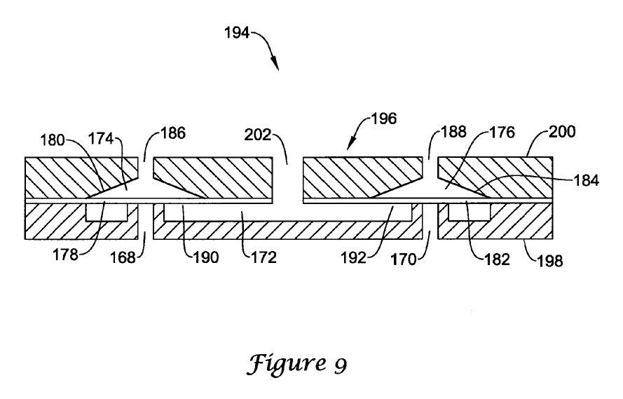

FIG. 9 diagrammatically illustrates a valve array 194 having a valve body 196 that includes a first side 198 and a second opposing side 200. First chamber 174 and second chamber 176, as discussed previously, are defined within valve body 196. Valve array 194 is identical to valve array 158 (see FIG. 8), with the exception that valve array 194 includes a valve array inlet 202 that is disposed on the first side 200 of valve body 196. Otherwise, valve array 194 functions identically to that discussed previously with respect to valve array 158 of FIG. 8.

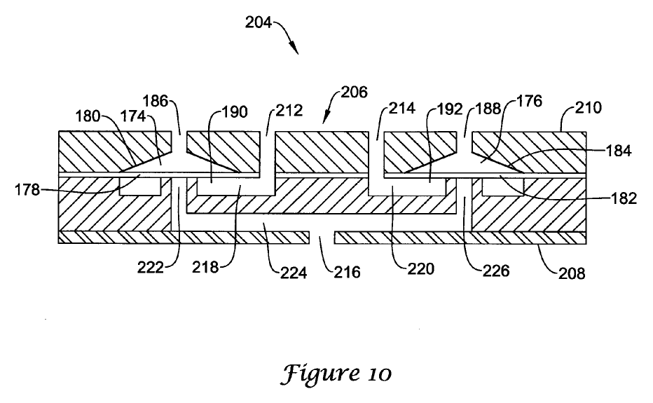

FIG. 10 diagrammatically illustrates a valve array 204 including a valve body 206 that has a first side 208 and a second opposing side 210. A first valve body inlet 212 and a second valve body inlet 214 are disposed along the second opposing side 210 of valve body 206. A valve body outlet 216 is disposed along the first side 208 of valve body 206. First chamber 174 and second chamber 176, as discussed previously, are defined within valve body 206.

First valve body inlet 212 is in fluid communication with a channel 218, which is itself in fluid communication with first inlet 190. Second valve body inlet 212 is in fluid communication with a channel 220, which is itself in fluid communication with second inlet 192.

It can be seen that fluid entering through first valve body inlet 212 will pass through channel 218. If diaphragm 178 of first chamber 174 is in its relaxed or rest position, as illustrated in FIG. 10, no fluid will flow into first chamber 174. However, if diaphragm 178 has been electrostatically actuated into an actuated position in which diaphragm 178 moves toward first pressure control port 186, fluid will be allowed to pass through to a first outlet 222. The fluid may then pass through a channel 224 and then exit through valve body outlet 216.

Similarly, if diaphragm 182 of second chamber 180 is in its relaxed or rest position, as illustrated in FIG. 10, no fluid will flow into second chamber 180. However, if diaphragm 182 has been electrostatically actuated into an actuated position in which diaphragm 182 moves toward second pressure control port 188, fluid will be allowed to pass through to a second outlet 226. The fluid may then pass through channel 224 and then exit through valve body outlet 216.

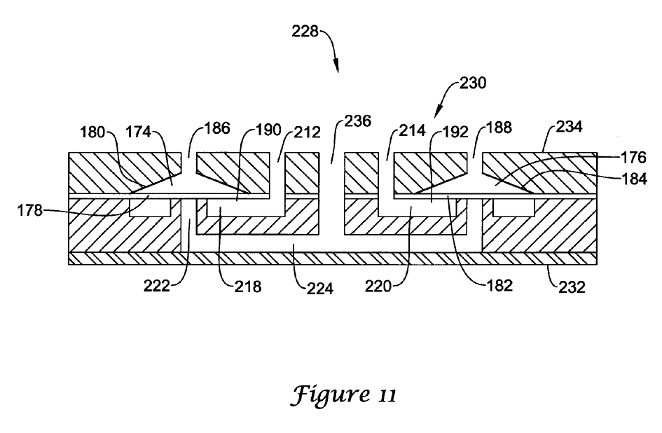

FIG. 11 diagrammatically illustrates a valve array 228 including a valve body 230 having a first side 232 and a second opposing side 234. First chamber 174 and second chamber 176, as discussed previously, are defined within valve body 230. Valve array 228 is identical to valve array 204 (see FIG. 10), with the exception that valve array 228 includes a valve array outlet 236 that is disposed on the second opposing side 234 of valve body 230. Valve array outlet 236 is in fluid communication with channel 224. Otherwise, valve array 228 functions identically to that discussed previously with respect to valve array 204 of FIG. 10.

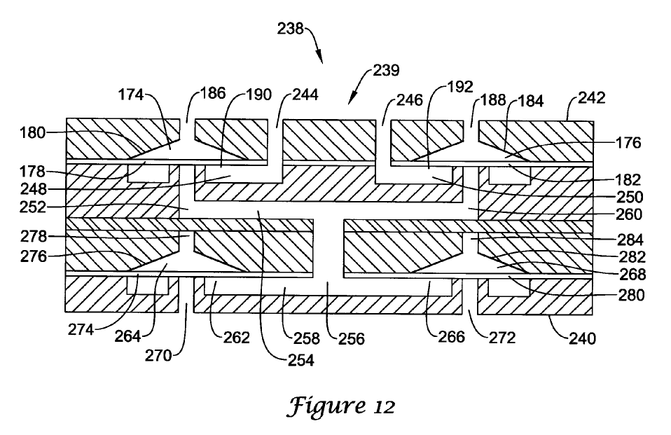

FIG. 12 diagrammatically illustrates a valve array 238 includes a valve body 239 that has a first side 240 and a second opposing side 242. A first valve body inlet 244 and a second valve body inlet 246 are disposed along second opposing side 242. First chamber 174 and second chamber 176, as discussed previously, are defined within valve body 240. First valve body inlet 244 is in fluid communication with a channel 248, which is itself in fluid communication with first inlet 190. Second valve body inlet 246 is in fluid communication with a channel 250, which is itself in fluid communication with second inlet 192.

It can be seen that fluid entering through first valve body inlet 244 will pass through channel 248. If diaphragm 178 of first chamber 174 is in its relaxed or rest position, as illustrated, no fluid will flow into first chamber 174. However, if diaphragm 178 has been electrostatically actuated into an actuated position in which diaphragm 178 moves toward first pressure control port 186, fluid will be allowed to pass through to a first outlet 252, pass through a channel 254, then into a channel 256 and then into a channel 258.

Similarly, if diaphragm 182 of second chamber 180 is in its relaxed or rest position, as illustrated, no fluid will flow into second chamber 180. However, if diaphragm 182 has been electrostatically actuated into an actuated position in which diaphragm 182 moves toward second pressure control port 188, fluid will be allowed to pass through to a second outlet 260, pass through channel 254, then into channel 256 and then into channel 258.

Channel 258 is in fluid communication with a third inlet 262 of a third chamber 264 and a fourth inlet 266 of a fourth chamber 268. Third chamber 264 has a third outlet 270 while fourth chamber 268 has a fourth outlet 272. Third chamber 264 includes an electrostatically actuated diaphragm 274 that is actuated by applying a voltage between an electrode present within or on diaphragm 274 and an electrode 276. A third pressure control port 278 may be provided to help diaphragm 274 flex or move under applied pressure. Likewise, fourth chamber 268 includes an electrostatically actuated diaphragm 280 that is actuated by applying a voltage between an electrode present within diaphragm 280 and an electrode 282. A fourth pressure control port 284 may be provided to help diaphragm 280 flex or move under applied pressure. Third pressure control port 278 and fourth pressure control port 284 may each be considered as including a fluid outlet not illustrated in this diagrammatic cross-sectional view.

It will be appreciated that any fluid that reaches channel 258 may or may not exit valve array 238. If diaphragm 274 of third chamber 264 is in its relaxed or rest position, as illustrated, no fluid will flow into third chamber 264. However, if diaphragm 274 has been electrostatically actuated into an actuated position in which diaphragm 274 moves toward third pressure control port 278, fluid will pass into third chamber 264 and then exit through third outlet 270.

Similarly, if diaphragm 280 of fourth chamber 268 is in its relaxed or rest position, as illustrated, no fluid will flow into fourth chamber 268. However, if diaphragm 280 has been electrostatically actuated into an actuated position in which diaphragm 280 moves toward fourth pressure control port 284, fluid will pass into fourth chamber 268 and then exit through fourth outlet 272.

It is instructive to note that if “A” equals the actuation of the first diaphragm 178, “B” equals the actuation of the second diaphragm 182, “C” equals the actuation of the third diaphragm 274, “D” equals the actuation of the fourth diaphragm 280, Out1 equals the output flow of the third output 270, and Out2 equals the output flow of the fourth output 272, this illustrative embodiment may be used to implement the function Out1=(A or B) and (C), and Out2=(A or B) and (D), where the activation of “A” allows the flow through the first valve body inlet 244, and activation of “B” allows the flow through the second valve body inlet 246. This is only illustrative of some logic functions that can be implemented with the present invention. Other logic function may be also be implemented to suit a desired application.

The invention should not be considered limited to the particular examples described above, but rather should be understood to cover all aspects of the invention as set out in the attached claims. Various modifications, equivalent processes, as well as numerous structures, including any plurality of arrayed valves, to which the invention can be applicable will be readily apparent to those of skill in the art upon review of the instant specification.

1. A switching valve array, comprising:
a valve body;
a first chamber defined within the valve body, the first chamber having a first inlet and a first outlet;
a first diaphragm disposed within the first chamber, the first diaphragm having a first position in which fluid flow into the first outlet is restricted, and an second position in which fluid flow into the first outlet is permitted;
a second chamber defined within the valve body, the second chamber having a second inlet and a second outlet;
a second diaphragm disposed within the second chamber, the second diaphragm having a first position in which fluid flow into the second outlet is restricted, and a second position in which fluid flow into the second outlet is permitted; and
a valve array inlet in fluid communication with the first inlet and the second inlet.

2. The switching valve array of claim 1, wherein the first diaphragm and the second diaphragm are adapted to be independently actuated to selectively prevent fluid entering the valve array inlet from exiting the first outlet or the second outlet, to permit said fluid to exit from one of the first outlet or the second outlet, or to permit said fluid to exit through both the first outlet and the second outlet.

3. The switching valve array of claim 1, wherein the valve body has a first surface and a second opposing surface, and the valve array inlet is on the first surface.

4. The switching valve array of claim 3, wherein the first inlet and the second inlet are on the first surface.

5. The switching valve array of claim 3, wherein the first inlet and the second inlet are on the second surface.

6. The switching valve array of claim 1, wherein the first chamber and the second chamber are each adapted to accommodate gas and/or liquid fluids.

7. The switching valve array of claim 1, wherein the first chamber further comprises a first normally open port positioned within the first chamber such that fluid entering the first chamber exits through the first normally open port when the first diaphragm is positioned to restrict fluid from entering the first outlet.

8. The switching valve array of claim 7, wherein the first diaphragm has at least one aperture positioned to permit fluid to flow from the first inlet to the first normally open port when the first diaphragm is in the first position.

9. The switching valve array of claim 1, wherein the second chamber further comprises a second normally open port positioned within the second chamber such that fluid entering the second chamber exits through the second normally open port when the second diaphragm is positioned to restrict fluid from entering the second outlet.

10. The switching valve array of claim 9, wherein the second diaphragm has at least one aperture positioned to permit fluid to flow from the second inlet to the second normally open port when the second diaphragm is in the first position.

11. The switching valve array of claim 1, wherein the first diaphragm and the second diaphragm are electrostatically actuated between the first position and the second position and/or between the second position and the first position.

12. The switching valve array of claim 1, wherein the first chamber further comprises a first pressure control port positioned such that fluid entering the first chamber is prevented from exiting the first pressure control port.

13. The switching valve array of claim 12, wherein the first diaphragm is configured to prevent fluid from passing from the first inlet to the first pressure control port.

14. The switching valve array of claim 1, wherein the second chamber further comprises a second pressure control port positioned such that fluid entering the second chamber is prevented from exiting the second pressure control port.

15. The switching valve array of claim 14, wherein the second diaphragm is configured to prevent fluid from passing from the second inlet to the second pressure control port.

16. The switching valve array of claim 1, further comprising:
an n^{th} chamber defined within the valve body, the n^{th} chamber having an n^{th} inlet and an n^{th} outlet, the n^{th} inlet in fluid communication with the valve array inlet; and
an n^{th} diaphragm disposed within the n^{th} chamber, the n^{th} diaphragm having a first position in which fluid flow into the n^{th} outlet is restricted, and a second position in which fluid flow into the n^{th} outlet is permitted;
wherein “n” is an integer greater than two.

17. A switching valve array, comprising:
a valve body;
a first chamber defined within the valve body, the first chamber having a first inlet and a first outlet;
a first diaphragm disposed within the first chamber, the first diaphragm having a first position in which fluid flow into the first outlet is restricted, and an second position in which fluid flow into the first outlet is permitted;
a second chamber defined within the valve body, the second chamber having a second inlet and a second outlet;
a second diaphragm disposed within the second chamber, the second diaphragm having a first position in which fluid flow into the second outlet is restricted, and a second position in which fluid flow into the second outlet is permitted; and
a valve array outlet in fluid communication with the first outlet and the second outlet.

18. A switching valve array, comprising:
a valve body;
a first chamber defined within the valve body, the first chamber having a first inlet and a first outlet;
a first diaphragm disposed within the first chamber, the first diaphragm having a first position in which fluid flow into the first outlet is restricted, and a second position in which fluid flow into the first outlet is permitted;
a second chamber defined within the valve body, the second chamber having a second inlet and a second outlet;
a second diaphragm disposed within the second chamber, the second diaphragm having a first position in which fluid flow into the second outlet is restricted, and a second position in which fluid flow into the second outlet is permitted;
a third chamber defined within the valve body, the third chamber having a third inlet and a third outlet, the third inlet in fluid communication with the first outlet and the second outlet;
a third diaphragm disposed within the third chamber, the third diaphragm having a first position in which fluid flow into the third outlet is restricted, and a second position in which fluid flow into the third outlet is permitted;
a fourth chamber defined within the valve body, the fourth chamber having a fourth inlet and a fourth outlet, the fourth inlet in fluid communication with the first outlet and the second outlet; and
a fourth diaphragm disposed within the fourth chamber, the fourth diaphragm having a first position in which fluid flow into the fourth outlet is restricted, and a second position in which fluid flow into the fourth outlet is permitted.

19. The electrostatically actuated switching valve array of claim 18, wherein fluid entering either or both of the first inlet and the second inlet may be selectively directed to either or both of the third outlet and the fourth outlet.

20. The electrostatically actuated switching valve array of claim 18, wherein each of the first chamber, the second chamber, the third chamber and the fourth chamber further comprise a normally open port positioned within each chamber such that fluid entering each chamber exits through each normally open port when each diaphragm is positioned to restrict fluid from entering the corresponding outlet.

21. The electrostatically actuated switching valve array of claim 18, wherein each of the first chamber, the second chamber, the third chamber and the fourth chamber further comprise a pressure control port positioned within each chamber such that fluid entering each chamber is prevented from exiting the corresponding pressure control port.
